(19) United States
(12) Patent Application Publication
(10) Pub. No.: US 2012/0077937 A1
(43) Pub. Date: Mar. 29, 2012

(54) Method For Preparing A Suspension Of PVC Grafted Onto An Elastomer

(76) Inventors: Thierry Pascal, Charly (FR); Bruno Brechard, Saint Cyr sur le Rhone (FR)

(21) Appl. No.: 13/320,377

(22) PCT Filed: May 6, 2010
(86) PCT No.: PCT/FR2010/050870

§ 371 Date: Dec. 7, 2011

(30) Foreign Application Priority Data
May 15, 2009 (FR) 0953234

(51) Int. Cl. C08F 8/18

(52) U.S. Cl. 525/317

(57) ABSTRACT

The invention pertains to the field of PVC production. More particularly, the invention relates to a method for preparing a polymer including vinyl chloride monomers that are polymerized and grafted onto acrylic, styrene, and/or ethylene monomers polymerized in the form of an elastomer.

The invention relates to the field of polyvinyl chloride (PVC) production. More particularly, the invention relates to a method for preparing a polymer comprising vinyl chloride monomers that are polymerized and grafted onto acrylic, styrene and/or ethylene monomers polymerized in the form of an elastomer.

The production of products based on PVC grafted onto an acrylic elastomer is already widely described in the prior art. The methods comprise two distinct steps. The first step relates to the preparation of an emulsion of acrylic polymer in water, generally carried out by emulsion polymerization or by means of a method of emulsification subsequent to a bulk or solution polymerization. The second step is intended for carrying out the polymerization of the VCM in the presence of the acrylic polymer emulsion. Two routes of access which differ in terms of the reaction processes involved can be envisioned for carrying out this second step to a successful conclusion: a reaction in suspension in water or a reaction in emulsion in water. The operating conditions of the second step are defined in such a way as to ensure, on the one hand, formation of the PVC and, on the other hand, grafting of the PVC onto the initial emulsion of acrylic polymer. This notion of grafting implies that a fraction of the suspension grains or of the emulsion particles, which are constituents of the product of the second step, are individually formed from a mixture of PVC and of acrylic polymer.

Examination of the prior work reveals that the first descriptions of a method for producing PVC grafted onto an elastomer are based on polymerization of the VCM in a suspension method. The acrylic polymer is then incorporated in the form of an emulsion in water, which is added during the initial phases of loading the polymerization reactor. These methods are illustrated in patents U.S. Pat. No. 4,981,907, U.S. Pat. No. 5,185,406 and U.S. Pat. No. 5,232,991.

The approach based on polymerization of the VCM in an emulsion method with the initial addition of an acrylic polymer in emulsion form is the subject of more recent descriptions illustrated, for example, by the application published under number EP 0 647 663. This method takes its inspiration from conventional synthesis protocols for emulsion polymerization on a seed which are discussed in general handbooks on the preparation of polymers in a dispersed phase in water, such as “Emulsion Polymerization and Emulsion Polymers” by P. A. Lovell and M. S. El-Aasser (Wiley).

In the particular case of the suspension methods, the synthesis protocols comprise an ingredient of polyelectrolyte type (for example, a divalent metal salt) which makes it possible to cause coagulation of the polyacrylic emulsion before or during the vinyl chloride monomer (VCM) polymerization step. This specific ingredient is added to the initial feedstock of the autoclave. In addition to this particularity, the method reproduces the conventional ingredients (mainly: colloids, pH regulators and free-radical initiator) and the usual conditions for suspension polymerization of the VCM. A detailed description of this type of method is given in the handbook entitled “Encyclopedia of PVC” Volume 1 edited by L. I. Nass and C. A. Heiberger (Marcel Dekker). The product obtained at the end of the reaction has the characteristics of a PVC slurry, i.e. it is made up of grains of polymer having an average diameter of between 100 and 300 μm, which are dispersed in water. This product can therefore be isolated via standard techniques for finishing a PVC suspension, comprising, for example, a phase of filtration by centrifugation and a phase of drying by heating under reduced pressure. The methods for processing these PVCs grafted onto acrylic elastomers produced by the suspension route are analogous to the method for standard PVC suspension grades (homopolymers or copolymers). Generally, these methods correspond to the various extrusion, injection-molding or hot-molding techniques which make it possible to obtain semi-manufactured objects (tubes, profiled elements, plates, sheets, films, molded components).

The obtaining of PVC grafted onto an elastomer via the suspension route is of major industrial interest since the majority (approximately 80%) of PVC resins consumed on the world market correspond to suspension grades.

The present invention aims in particular to overcome two drawbacks of suspension grafting methods.

The first drawback relates to the initial incorporation of the acrylic elastomer in the form of an emulsion in water. Emulsions in water, more commonly called latex, consist of elementary particles of polymers having diameters typically less than 5 μm, the homogeneous dispersion of which in water is stabilized by ionic or nonionic surfactants. The dry matter or dry extract content of the emulsions is generally between 30 and 50% by weight. A well-known drawback in the handling of latexes results from their mechanical or thermal instability that can pose problems when they are used in production plants (draining, storing, pumping or feeding phases) or when they are transported to another plant. Indeed, coagulation of the latex can be observed under the influence of a shear stress, during time spent at too high a temperature or during freezing. Added to this problem of instability is the presence of a considerable fraction of water, between 70 and 50% by weight, which puts a burden on transport costs. Finally, the use of a latex can require a modification of production tools since, in the majority of industrial plants, this latex is not used as it is, but undergoes a drying treatment so as to make it possible to isolate and sell the elastomer product in powder form.

The second drawback lies in the coagulation of the acrylic elastomer latex before or during the VCM polymerization step. This latex coagulation is necessary in order to form aggregates of elementary particles of defined size, which makes it possible, firstly, to avoid the presence in the final slurry of ultrafine grains (<10 μm) which are prejudicial to the filtration by centrifugation, and, secondly, to control the size distribution and the morphology of the grains of grafted resin. This coagulation process, brought about by the initial addition of a polyelectrolyte, is difficult to reproduce since it depends on the stability of the latex, which varies according to its thermomechanical history and the operating conditions of the polymerization (stirring, temperature, other ingredients present, pH of the medium). Furthermore, it is generally accepted that latex coagulation in a reactor presents a risk with regard to the formation of a polymer deposit on the walls or on the stirrer spindle, which is disadvantageous in terms of productivity. This coagulation process can also lead to problems linked to aqueous effluents containing a divalent metal (Ca, Al, Mg, etc.).

The method which is the subject of the invention aims to solve the drawbacks of the abovementioned methods in particular by replacing the step consisting in introducing the elastomer in the form of an emulsion in water, with a step consisting in introducing the elastomer in the form of a powder that can be obtained by spray-drying an elastomer emulsion.

The subject of the invention is therefore a method for preparing a grafted polymer, said polymer comprising vinyl chloride monomers that are polymerized and acrylic, styrene and/or ethylene monomers that are polymerized in the form of an elastomer, said method comprising the following steps:
(a) charging water and at least one protective colloid to a reactor, then
(b) adding, with stirring, an acrylic, styrene and/or ethylene elastomer in powder form, so as to obtain a dispersion, then
(c) adding an initiator capable of forming free radicals, which is soluble in the vinyl chloride, and vinyl chloride monomers with optionally other monomers that may be copolymerized with the vinyl chloride monomers, so as to obtain a suspension, and
(d) heating the reaction medium at a temperature ranging from 50° C. to 80° C. before, during or after step (c) so as to obtain said polymer.

The incorporation of an elastomer in powder form, and preferably in dry powder form, into the suspension production method which is the subject of the invention makes it possible to avoid the disadvantages inherent in the use of an elastomer latex emulsion in water: problem of thermomechanical instability of latexes, possible transport of a product comprising a considerable fraction of water, risk of encrusting of the VCM polymerization reactor.

The method which is the subject of the invention also has the following advantages: use of the elastomer product conditioned in its commercial powder form, greater reproducibility due to elimination of the coagulation step during the production of the grafted resin.

The acrylic, styrene and/or ethylene elastomer in powder form, added in step (b), has an average particle size of between 10 and 200 μm. This elastomer in powder form can be obtained by spray-drying an elastomer latex. Techniques for drying by means of spray-drying are commonly used on the industrial scale to obtain elastomer powders, which are subsequently used to produce formulations based on various thermoplastic polymers. The elastomer in powder form is made up of grains of which the average sizes are between 10 and 200 μm according to the type of spray-dryer used (nozzle spraying or turbine spraying) and the operating conditions thereof. These grains can then undergo a milling step in order to obtain a particle size suitable for the final use of the product. Preferably, the elastomer latex is obtained by polymerization of acrylic, styrene and/or ethylene monomers in an emulsion in water.

For the purpose of the present invention, the term “elastomer” is intended to mean a polymer or copolymer which has a glass transition temperature less than or equal to 0° C. Such a polymer or copolymer preferably has a Young's modulus, measured at the temperature at which it is used, of between 10 000 Pa and 100 000 000 Pa, and preferably between 50 000 Pa and 10 000 000 Pa.

Among the elastomers that can be used during step (b), mention may be made, as nonexclusive examples, of polybutadiene, polyisoprene, polychloroprene and their hydrogenated versions, polyisobutylene, block copolymers of polybutadiene and of isoprene with styrene, and also their hydrogenated versions such as poly(styrene-b-butadiene) (SB), poly(styrene-b-butadiene-b-styrene) (SBS), poly(styrene-b-isoprene-b-styrene) (SIS), poly(styrene-b-(isoprene-stat-butadiene)-b-styrene) or poly(styrene-b-isoprene-b-butadiene-b-styrene) (SIBS), hydrogenated SBS (SEBS), poly(styrene-b-butadiene-b-methyl methacrylate) (SBM), and also its hydrogenated version (SEBM), poly(methyl methacrylate-b-butyl acrylate-b-methyl methacrylate) (MAM), poly(styrene-b-butyl acrylate-b-styrene) (SAS), random copolymers of butadiene with styrene (SBR) and acrylonitrile (NBR) and their hydrogenated versions, butyl or halogenated rubbers, polyethylenes, polypropylenes, ethylene/vinyl alcohol copolymers, ethylene/propylene and ethylene/propylene/diene (EPDM) copolymers, copolymers of ethylene with acrylic and vinyl monomers, such as copolymers of ethylene and vinyl acetate, copolymers of ethylene, vinyl acetate and maleic anhydride, available from the company ARKEMA under the trade name OREVAC®, copolymers of ethylene and acrylic ester, copolymers of ethylene, acrylic ester and maleic anhydride, copolymers of ethylene, acrylic ester and functional acrylic ester, such as glycidyl acrylate or methacrylate, available from the company ARKEMA under the trade name LOTADER®, flexible acrylic polymers or copolymers, for instance resins based on acrylic esters, such as polybutyl acrylate and copolymers thereof with styrene, or other acrylic or vinyl monomers, and also blends thereof.

The elastomers can in particular be chosen from the following products:
the acrylic derivatives sold by the company ARKEMA under the trade names Durstrength® 200, 320, 340 and 360, the acrylic derivatives sold by the company Rohm & Haas under the trade names Paraloid® KM342, KM342B, KM361, KM370 and KM1, the acrylic derivatives sold by the company KANEKA under the trade names FM22® and FM 50®,
the acrylic-styrene derivatives sold by the company ARKEMA under the trade name Clearstrength® W300,
the MBSs sold by the company ARKEMA under the trade names Clearstrength® C140, C320, C223, C859 and C303H; the MBSs sold by the company Rohm & Haas under the trade names Paraloid@ BTA 702S, 707, 717, 730, 736S and 780S; and the MBSs sold by the company Kaneka under the trade names Kane Ace® B11A, 22, 28A, 38A and 56.

The aqueous dispersion comprising water, the colloid and the elastomer, obtained at the end of step (b), is used for the suspension polymerization of the vinyl chloride monomers, during step (c). During this step, the initiator capable of forming free radicals, and the vinyl chloride monomers with optionally other monomers that may be copolymerized with the vinyl chloride are added. Water may also be added. The order in which these components are added can vary. Before, during or after this addition, the reaction medium is heated at a temperature ranging from 50° C. to 80° C. Preferably, this step (c) is carried out with stirring, and entirely preferably, the stirring begins before the addition of the vinyl chloride monomers, and continues throughout step (c).

During the polymerization, 1 to 5 parts by weight, preferably 1 to 3 parts by weight, of water are used per part by weight of vinyl chloride or of mixture comprising vinyl chloride monomers.

The proportion of elastomer contained in the grafted polymer in accordance with the invention may be easily adjusted by those skilled in the art by varying either the amount of elastomer powder added in step (b), or the amount of vinyl chloride monomers used during step (c). Preferably, the polymer obtained according to the method which is the subject of the invention will comprise 15 to 70% by weight, relative to the total weight of the polymer, of acrylic, styrene and/or ethylene monomers.

Preferably, the monomers that may be copolymerized with the vinyl chloride are chosen from vinyl acetate, vinyl propionate, vinyl butyrate, vinyl 2-ethylhexanoate, vinyl isotridecanoic esters, vinylidene chloride, vinyl ethers, maleic acid, fumaric acid, acrylic acid and methacrylic acid and their monoesters and diesters with aliphatic alcohols containing 1 to 10 carbon atoms, maleic anhydride, maleic imide, and products resulting from the N-substitution of said monomers, with aromatic or cycloaliphatic groups. Preferably, said monomers are chosen from vinyl acetate and methacrylates.

In one particular embodiment of the invention, a precipitating agent chosen from alkali metal salts, alkaline-earth metal salts and organic and inorganic acid salts is added during step (a). This addition makes it possible to avoid an elastomer emulsion being formed or reconstituted during step (b), which consists in adding the elastomer in powder form. This precipitating agent may, for example, be chosen from magnesium sulfate, calcium chloride, calcium acetate, barium chloride, barium nitrate, aluminum chloride, potassium aluminum sulfate and ferric chloride. The precipitating agent is generally incorporated in an aqueous solution.

The initiator capable of forming free radicals, which is soluble in the vinyl chloride, is preferably a peroxide or an azo compound, having a half-life of 1 to 20 hours at the polymerization temperature. Mention may be made of peroxides, dialkyl, diacyl and diaroyl peroxides; peroxydicarbonates and peresters. Examples of azo initiators are azobisisobutyronitrile and azobisdimethylvaleronitrile. If necessary, reducing agents may also be added. The initiators may be used alone or as a mixture at concentrations ranging preferably from 0.01 to 1% by weight, relative to the weight of the vinyl chloride monomers.

A protective colloid chosen from partially hydrolyzed poly(vinyl acetate)s and cellulosic polymers, preferably compounds of hydroxypropylmethylcellulose type, is preferably used as protective colloid.

The method which is the subject of the invention may comprise additional steps.

Thus, during step (c), before the addition of the vinyl chloride monomer, a vacuum can be created in order to remove the oxygen present.

At the end of step (d), it is possible to provide for an additional step of maintaining the reaction medium at a constant temperature until a fixed conversion is obtained. This conversion is defined, for example, on the basis of a reaction time, of a heat balance or of a drop in pressure of generally between −0.1 and −5 bar, relative to the initial vinyl chloride monomer pressure at the reaction temperature. The fixed conversion is generally between 45 and 90%, and preferably from 70% to 80% by weight, relative to the vinyl chloride monomer used.

At the end of step (d), it is possible to provide for a step of degassing and evaporation of the residual vinyl chloride monomers.

The product obtained using the method which is the subject of the invention at the end of step (d) has the characteristics of a PVC slurry, i.e. it is made up of grains of polymer having an average diameter of between 100 and 300 μm, which are dispersed in water. This product can be isolated via standard techniques for finishing a PVC suspension, comprising, for example, a phase of filtration by centrifugation and a phase of drying by heating under reduced pressure. A powder composed of grains having an average diameter of between 100 and 500 μm, preferably between 100 and 300 μm, is then obtained.

The methods for processing the PVC grafted onto elastomers produced according to the method which is the subject of the invention are analogous to the method for standard PVC suspension grades (homopolymers or copolymers). Generally, these methods correspond to the various extrusion, injection-molding or hot-molding techniques which make it possible to obtain semi-manufactured objects (tubes, profiled elements, plates, sheets, films, molded components).

The copolymers obtained by the method which is the subject of the invention have good flowability properties and a high density.

They can be used in pure form or as a blend with a standard grade of PVC, without plasticizer or with a reduced proportion of plasticizer, for the production of semi-rigid or flexible PVC-based objects. It is thus possible to use the product obtained according to the method of the invention for semi-rigid or flexible PVC applications, without the addition of plasticizer or with a small proportion of plasticizer compared with a formulation containing a standard grade of PVC suspension or emulsion (homopolymer or copolymer). The product obtained according to the method of the invention also has advantages in terms of Shore hardness/Vicat compromise and of temperature stability compared with known formulations containing plasticizers.

They can be used as an impact modifier in PVC formulations.

### EXAMPLES

### Example 1

PVC Grafted onto Acrylic Obtained by Means of a Suspension Method Using a Spray-Dried Powder of Elastomer/Level of Acrylic=17%

11 liters of deionized water are introduced, at ambient temperature, into a 30 liter autoclave equipped with a stirrer spindle of Impeller® type. 2.82 g of colloid based on an 88% hydrolyzed polyvinyl alcohol (Gohsenol GH20® from Nippon Gohsei), 2.50 g of colloid based on a 72% hydrolyzed polyvinyl alcohol (Alcotex B72® from Synthomer), 1.26 g of colloid based on a 55% hydrolyzed polyvinyl alcohol (Polivic S404W® from 3V Sigma) and 14 g of calcium chloride are added. The autoclave is closed. The stirring speed is brought to 100 rpm and 1011 g of polybutyl acrylate-based acrylic elastomer powder (Durastrength D340® from Arkema) are introduced over the course of 5 minutes and are dispersed for 5 minutes. 7.79 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 7 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./min. After a period of 30 minutes at the temperature of 56.5° C., an amount of 2.72 liters of water is injected at a constant flow rate over a period of 240 minutes. The reaction is continued until there is a drop in pressure of −1 bar relative to the initial VCM pressure at a temperature of 56.5° C. At this level of pressure drop, the autoclave is cooled to 50° C. by injection, into the jacket, of water at 18° C. The total reaction time from the end of the heating ramp up to −1 bar is 350 minutes. At 50° C. and with stirring reduced to 250 rpm, the VCM is degassed and then the autoclave is placed under a dynamic vacuum for 4 hours in order to remove the residual VCM.

19.590 kg of suspension slurry are thus recovered. The slurry is drained with suction and dried on a fluidized bed for 48 hours at ambient temperature. The weight of grafted resin after drying is 5.870 kg. The average diameter of the suspension grains, measured with a Malvern MasterSizer 2000 particle size analyzer, comes to 430 μm.

### Example 2

PVC Grafted onto Acrylic Obtained by Means of a Suspension Method Using a Spray-Dried Powder of Elastomer/Level of Acrylic=17%

11 liters of deionized water are introduced, at ambient temperature, into a 30 liter autoclave equipped with a stirrer spindle of impeller type. 5.64 g of colloid based on an 88% hydrolyzed polyvinyl alcohol (Gohsenol GH20200 from Nippon Gohsei), 5 g of colloid based on a 72% hydrolyzed polyvinyl alcohol (Alcotex B72® from Synthomer), 1.26 g of colloid based on a 55% hydrolyzed polyvinyl alcohol (Polivic S404W® from 3V Sigma) and 14 g of calcium chloride are added. The autoclave is closed. The stirring speed is brought to 100 rpm and 1011 g of polybutyl acrylate-based acrylic elastomer powder (Durastrength D340® from Arkema) are introduced over the course of 5 minutes and are dispersed for 5 minutes. 10.5 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 7 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./min. After a period of 30 minutes at the temperature of 56.5° C., an amount of 2.30 liters of water is injected at a constant flow rate over a period of 230 minutes. The reaction is continued until there is a drop in pressure of −1 bar relative to the initial VCM pressure at the temperature of 56.5° C. At this level of pressure drop, the autoclave is cooled to 50° C. by injecting water, at 18° C., into the jacket. The total reaction time from the end of the heating ramp up to −1 bar is 264 minutes. At 50° C. with stirring reduced to 250 rpm, the VCM is degassed and then the autoclave is placed under a dynamic vacuum for 4 hours in order to remove the residual VCM.

19.220 kg of suspension slurry are thus recovered. The slurry is drained with suction and dried on a fluidized bed for 48 hours at ambient temperature. The weight of grafted resin after drying is 5.920 kg. The average diameter of the suspension grains, measured with a Malvern MasterSizer 2000 particle size analyzer, comes to 263 μm.

### Example 3

PVC Grafted onto Acrylic Obtained by Means of a Suspension Method Using a Spray-Dried Powder of Elastomer/Level of Acrylic=16%

11 liters of deionized water are introduced, at ambient temperature, into a 30 liter autoclave equipped with a stirrer spindle of impeller type. 5.64 g of colloid based on an 88% hydrolyzed polyvinyl alcohol (Gohsenol GH20® from Nippon Gohsei), 10 g of colloid based on a 72% hydrolyzed polyvinyl alcohol (Alcotex B72® from Synthomer), 1.26 g of colloid based on a 55% hydrolyzed polyvinyl alcohol (Polivic S404W® from 3V Sigma) and 14 g of calcium chloride are added. The autoclave is closed. The stirring speed is brought to 100 rpm and 1011 g of polybutyl acrylate-based acrylic elastomer powder (Durastrength D340® from Arkema) are introduced over the course of 5 minutes and are dispersed for 5 minutes. 10.5 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 7 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./min. After a period of 30 minutes at the temperature of 56.5° C., an amount of 2.30 liters of water is injected at a constant flow rate over a period of 230 minutes. The reaction is continued until there is a drop in pressure of −1 bar relative to the initial VCM pressure at the temperature of 56.5° C. At this level of pressure drop, the autoclave is cooled to 50° C. by injecting water, at 18° C., into the jacket. The total reaction time from the end of the heating ramp up to −1 bar is 244 minutes. At 50° C. with stirring reduced to 250 rpm, the VCM is degassed and then the autoclave is placed under a dynamic vacuum for 4 hours in order to remove the residual VCM.

19.640 kg of suspension slurry are thus recovered. The slurry is drained with suction and dried on a fluidized bed for 48 hours at ambient temperature. The weight of grafted resin after drying is 6.340 kg. The average diameter of the suspension grains, measured with a Malvern MasterSizer 2000 particle size analyzer, comes to 180 μm.

### Example 4

PVC Grafted onto Acrylic Obtained by Means of a Suspension Method Using a Spray-Dried Powder of Elastomer/Level of Acrylic=18%

11 liters of deionized water are introduced, at ambient temperature, into a 30 liter autoclave equipped with a stirrer spindle of impeller type. 5.64 g of colloid based on an 88% hydrolyzed polyvinyl alcohol (Gohsenol GH20® from Nippon Gohsei), 5 g of colloid based on a 72% hydrolyzed polyvinyl alcohol (Alcotex B72® from Synthomer) and 1.26 g of colloid based on a 55% hydrolyzed polyvinyl alcohol (Polivic S404W® from 3V Sigma) are added. The autoclave is closed. The stirring speed is brought to 100 rpm and 1011 g of polybutyl acrylate-based acrylic elastomer powder (Durastrength D340® from Arkema) are introduced over the course of 5 minutes and are dispersed for 5 minutes. 10.5 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 7 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./min. After a period of 30 minutes at the temperature of 56.5° C., an amount of 2.30 liters of water is injected at a constant flow rate over a period of 230 minutes. The reaction is continued until there is a pressure drop of −1 bar relative to the initial VCM pressure at the temperature of 56.5° C. At this level of pressure drop, the autoclave is cooled to 50° C. by injecting water, at 18° C., into the jacket. The total reaction time from the end of the heating ramp up to −1 bar is 232 minutes. At 50° C. with stirring reduced to 250 rpm, the VCM is degassed and then the autoclave is placed under a dynamic vacuum for 4 hours in order to remove the residual VCM.

18.980 kg of suspension slurry are thus recovered. The slurry is drained with suction and dried on a fluidized bed for 48 hours at ambient temperature. The weight of grafted resin after drying is 5.580 kg. The suspension slurry obtained is very coarse; the average diameter of the grains was estimated visually at 5 mm.

### Example 5

PVC Grafted onto Acrylic Obtained by Means of a Suspension Method Using a Spray-Dried Powder of Elastomer/Level of Acrylic=38%

11 liters of deionized water are introduced, at ambient temperature, into a 30 liter autoclave equipped with a stirrer spindle of impeller type. 11.9 g of colloid based on an 80% hydrolyzed polyvinyl alcohol (Mowiol 15-79® from Kuraray) and 42 g of calcium chloride are added. The autoclave is closed. The stirring speed is brought to 100 rpm and 2557 g of polybutyl acrylate-based acrylic elastomer powder (Durastrength D340® from Arkema) are introduced over the course of 5 minutes and are dispersed for 5 minutes. 15 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 6.3 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./rain. After a period of 30 minutes at the temperature of 56.5° C., an amount of 2.30 liters of water is injected at a constant flow rate over a period of 230 minutes. The reaction is continued until there is a pressure drop of −1 bar relative to the initial VCM pressure at the temperature of 56.5° C. At this level of pressure drop, the autoclave is cooled to 50° C. by injecting water, at 18° C., into the jacket. The total reaction time from the end of the heating ramp up to −1 bar is 210 minutes. At 50° C. with stirring reduced to 250 rpm, the VCM is degassed and then the autoclave is placed under a dynamic vacuum for 4 hours in order to remove the residual VCM.

20.020 kg of suspension slurry are thus recovered. The slurry is drained with suction and dried on a fluidized bed for 48 hours at ambient temperature. The weight of grafted resin after drying is 6.700 g. The average diameter of the suspension grains, measured with a Malvern MasterSizer 2000 particle size analyzer, comes to 163 μm.

### Example 6

PVC Grafted onto Acrylic Obtained by Means of a Suspension Method Using a Spray-Dried Powder of Elastomer/Level of Acrylic=39%

11 liters of deionized water are introduced, at ambient temperature, into a 30 liter autoclave equipped with a stirrer spindle of impeller type. 11.9 g of colloid based on an 80% hydrolyzed polyvinyl alcohol (Mowiol 15-79® from Kuraray) are added. The autoclave is closed. The stirring speed is brought to 100 rpm and 2557 g of polybutyl acrylate-based acrylic elastomer powder (Durastrength D340® from Arkema) are introduced over the course of 5 minutes and are dispersed for 5 minutes. 15 g of an emulsion at 60% by weight in water of 2-ethylhexyl peroxydicarbonate (Luperox 226EN60® from Arkema) are then added. The stirring speed is increased to 330 rpm and a vacuum is pulled at a pressure of 0.04 bar for 30 minutes. 6.3 kg of VCM are charged thereto. The mixture is left to stir for 25 minutes at ambient temperature. The temperature of the reaction medium is then brought to 56.5° C. by heating the autoclave by means of its jacket according to a heating ramp at 2° C./rain. After a period of 30 minutes at the temperature of 56.5° C., an amount of 2.30 liters of water is injected at a constant flow rate over a period of 230 minutes. The reaction is continued until there is a pressure drop of −1 bar relative to the initial VCM pressure at the temperature of 56.5° C. At this level of pressure drop, the autoclave is cooled to 50° C. by injecting water, at 18° C., into the jacket. The total reaction time from the end of the heating ramp up to −1 bar is 212 minutes. At 50° C. with stirring reduced to 250 rpm, the VCM is degassed and then the autoclave is placed under a dynamic vacuum for 4 hours in order to remove the residual VCM.

19.870 kg of suspension slurry are thus recovered. The slurry is drained with suction and dried on a fluidized bed for 48 hours at ambient temperature. The weight of grafted resin after drying is 6.550 g. The suspension slurry obtained is very coarse; the average diameter of the grains was estimated visually at 2 mm.

1. A method for preparing a grafted polymer, said polymer comprising vinyl chloride monomers that are polymerized and acrylic, styrene and/or ethylene monomers that are polymerized in the form of an elastomer, said method comprising at least the following steps:
(a) charging water and at least one protective colloid to a reactor, then
(b) adding, with stirring, an acrylic, styrene and/or ethylene elastomer in powder form, so as to obtain a dispersion, then
(c) adding an initiator capable of forming free radicals, which is soluble in the vinyl chloride, and vinyl chloride monomers with optionally other monomers that may be copolymerized with the vinyl chloride monomers, so as to obtain a suspension, and (d) heating the reaction medium at a temperature ranging from 50° C. to 80° C. before, during or after step (c) so as to obtain said polymer.

2. The method as claimed in claim 1, wherein a precipitating agent chosen from alkali metal salts, alkaline-earth metal salts and organic and inorganic acid salts is added during step (a).

3. The method as claimed in claim 2, wherein the precipitating agent is chosen from magnesium sulfate, calcium chloride, calcium acetate, barium chloride, barium nitrate, aluminum chloride and potassium aluminum sulfate.

4. The method as claimed in claim 1, wherein the acrylic, styrene and/or ethylene elastomer in powder form, added in step (b), was obtained by spray-drying a latex of said elastomer.

5. The method as claimed in claim 4, wherein the latex of said elastomer is obtained by polymerization of acrylic, styrene and/or ethylene monomers in an emulsion in water.

6. The method as claimed in claim 1, wherein said grafted polymer comprises 15 to 70% by weight, relative to the total weight of the polymer of acrylic, styrene and/or ethylene monomers.

7. The method as claimed in claim 1, wherein the monomers that may be copolymerized with the vinyl chloride are chosen from vinyl acetate, vinyl propionate, vinyl butyrate, vinyl 2-ethylhexanoate, vinyl isotridecanoic esters, vinylidene chloride, vinyl ethers, maleic acid, fumaric acid, acrylic acid and methacrylic acid and their monoesters and diesters with aliphatic alcohols containing 1 to 10 carbon atoms, maleic anhydride, maleic imide, and products resulting from the N-substitution, of said monomers, with aromatic or cycloaliphatic groups.

8. The method as claimed in claim 1, wherein during step (c), before the addition of the vinyl chloride monomer, a vacuum is created in order to remove the oxygen present.

9. The method as claimed in claim 1, wherein the initiator capable of forming free radicals is chosen from dialkyl, diacyl and diaroyl peroxides, and peroxydicarbonates, peresters, azobisisobutyronitrile and azobisdimethylvaleronitrile.

10. The method as claimed in claim 1, wherein the protective colloid is chosen from partially hydrolyzed poly(vinyl acetate)s and cellulose derivatives, preferably hydroxypropylmethylcellulose.

11. A grafted polymer, said polymer comprising vinyl chloride monomers that are polymerized and grafted onto a styrene polymer.

12. The polymer as claimed in claim 11, in which the styrene polymer is chosen from block copolymers of polybutadiene and of isoprene with styrene, poly(styrene-b-butadiene) (SB), poly(styrene-b-butadiene-b-styrene) (SBS), poly(styrene-b-isoprene-b-styrene) (SIS), poly(styrene-b-(isoprene-stat-butadiene)-b-styrene) or poly(styrene-b-isoprene-b-butadiene-b-styrene) (SIBS), hydrogenated SBS (SEBS), poly(styrene-b-butadiene-b-methyl methacrylate) (SBM), and also its hydrogenated version (SEBM), poly(styrene-b-butyl acrylate-b-styrene) (SAS), random copolymers of butadiene with styrene (SBR) and acrylonitrile (NBR) and their hydrogenated versions, resins based on acrylic esters and copolymerized with styrene, and acrylic-styrene derivatives.
